(19) United States
(12) Patent Application Publication
(10) Pub. No.: US 2024/0407405 A1
(43) Pub. Date: Dec. 12, 2024

(54) PROCESS FOR REMOVING LIPOPHILIC OFF-FLAVORS FROM PLANT PROTEINS

(71) Applicant: NEW SCHOOL FOODS INC., Toronto (CA)

(72) Inventors: Rebecca MILLER, Toronto (CA); Christopher BRYSON, Toronto (CA)

(21) Appl. No.: 18/741,431

(22) Filed: Jun. 12, 2024

Related U.S. Application Data
(60) Provisional application No. 63/472,454, filed on Jun. 12, 2023.

(51) Int. Cl. A23L 5/20; A23J 3/14; B01D 15/08; B01J 20/26; B01J 20/28

(52) U.S. Cl. CPC A23L 5/273; A23J 3/14; B01D 15/08; B01J 20/261; B01J 20/28064

(57) ABSTRACT

A method for removal of off-flavors from a raw protein solution is provided. The method utilizes hydrophobic adsorption resin and/or zeolite surfaces with a high surface area.

### CROSS-REFERENCE TO RELATED APPLICATIONS

This application claims the benefit and priority from U.S. provisional application No. 63/472,454, filed on Jun. 12, 2023 and titled PROCESS FOR REMOVING LIPOPHILIC OFF-FLAVORS FROM PLANT PROTEINS, the entire content of which is incorporated herein by reference.

### FIELD

The present disclosure generally relates to the field of plant protein processing and in particular methods of removing off-flavor compounds from plant proteins.

### BACKGROUND

Extraction processes for purifying plant-based proteins from their source material often result in the co-purification of naturally occurring compounds that possess unpleasant and characteristically “planty” tastes such as bitterness and grassiness. To meet the growing demand for plant-based meat analogs that match the taste and nutritional quality of animal-based alternatives, a technique is needed to remove these off-flavors. The most problematic off-flavor molecules are hydrophobic compounds produced by the enzymatic and non-enzymatic degradation of endogenously occurring lipids. In legumes, cereals, and oilseed protein isolates, lipid oxidation is accelerated by lipoxygenases to produce aldehydes, ketones, and alcohols that are responsible for the characteristic “grassy” and “cardboard” off-notes found in the resultant protein isolates. In tuber protein isolates, lipolytic acyl hydrolase activity produces free fatty acids that contribute to pungent off-notes that are not easily masked. Improved methods are therefore needed to remove the off-flavor molecules for plant-based protein processing.

US20220264907 A1 discloses a technique for the purification of protein from plant material involving a step where the feedstock is applied hydrophobic column adsorption. However, this method is limited in terms of the viscosity of the feed solution that is treated. Due to the tendency for concentrated and viscous proteinaceous feedstocks to aggregate and clog column-based setups, only a dilute protein mixture can be passed through a packed bed column configuration.

### SUMMARY

Plant-based protein isolates and concentrates contain naturally occurring “off-flavors” compounds that are responsible for their offensive taste. Here we present a method for improving the taste of plant-based proteins by extracting small hydrophobic molecules from a concentrated protein solution using hydrophobic adsorbent resin. The hydrophobic adsorbent resin adsorbs and sequesters off-flavors from plant-based protein solutions, greatly enhancing their taste. This method is applicable to proteins from various plant sources, including but not limited to legumes, oilseeds, cereals, and tubers.

In one aspect, a method for removal of lipid-derived off-flavor molecules from a raw protein solution is provided, the method comprising contacting the protein solution with a high surface area hydrophobic adsorption resin and/or zeolite surface, and collecting an eluate from said hydrophobic adsorption resin and/or zeolite surface, the eluate having reduced lipid-derived off-flavor molecule content compared to the raw protein solution.

In one embodiment, the hydrophobic adsorption resin and/or zeolite surface is an aromatic hydrophobic adsorption resin surface. In one embodiment, the hydrophobic adsorption resin and/or zeolite surface comprises a hydrophobic adsorption resin and/or zeolite bead.

In one embodiment, the hydrophobic adsorption resin and/or zeolite surface has a surface area of at least 500 m²/g, at least 600 m²/g, at least 700 m²/g, at least 800 m²/g, at least 900 m²/g, at least 1000 m²/g.

In one embodiment, the raw protein solution comprises an aqueous solution. In one embodiment, the raw protein solution comprises 0.5% -50% solids.

In one embodiment, the method comprises batch-wise removal of the lipid-derived off-flavor molecules from the raw protein solution. In one embodiment, the raw protein solution is a viscous protein solution. In one embodiment, the raw protein solution comprises 5% or more solids.

In one embodiment, the method comprises dispersing the hydrophobic adsorption resin and/or zeolite surface in the raw protein solution to form a mixture, agitating the mixture, and separating the eluate from the mixture. In one embodiment, the method comprises continuously agitating the mixture for at least 30 minutes.

In one embodiment, the method is for selective removal of lipid-derived off-flavor molecules.

In one embodiment, the raw protein solution comprises protein from pea, soy, chickpea, faba, mung bean, rice, oat, or potato isolates or concentrates, or combinations thereof.

In one embodiment, the hydrophobic adsorption resin and/or zeolite surface is made from poly(styrene-divinylbenzene) and/or polymethacrylate.

In one embodiment, the method further comprises concentrating the eluate via filtration after removal of the lipid-derived off-flavor molecules. In one embodiment, the method further comprises spray drying the protein from the eluate after removal of the lipid-derived off-flavor molecules. In one embodiment, the method further comprises regenerating the resin and/or zeolite surface for reuse. In one embodiment, the elute is subjected to further food production processes where no further protein concentrating is needed

### DETAILED DESCRIPTION

Plant-based protein isolates and concentrates contain naturally occurring “off-flavors” compounds that are responsible for their offensive taste. These off-flavors compounds are co-purified along with protein during plant protein extraction processes, and cause bitterness, astringency, beany-ness, and/or grassiness in plant-based food products made from the extracted proteins. These off-flavors are a “giveaway” that the food product is made from plant materials. Removal of these off-flavors compounds has been a long standing challenge in the industry for which a solution has been elusive. Consequently, current plant-based food products often rely on adding flavor (i.e. salt, sugar, and spices) to mask the off-flavors.

While dozens of off-flavor molecules contribute to the flavor of plant proteins, the most malodorous are hydrophobic small molecules that originate from enzymatic and non-enzymatic lipid oxidation and/or hydrolysis, namely aliphatic aldehydes, ketones, and alcohols. These flavor compounds include but are not limited to hexanal (responsible for a green, hay-like taste), nonanol and (E,E)-2,4-nonadienal (cardboard), 1-octen-3-one (beany, musty, earthy), pentanol, and 3-methyl-1-butanol (beany), as detailed in Table 1. In tubers, the enzymes lipolytic acyl hydrolase and transferases are responsible for converting triacylglyerides into free fatty acids and their degradation products that result in pungent off-flavors that are difficult to mask by other means.

To meet rising consumer demand for plant-based products that are organoleptically and nutritionally equivalent to their animal counterparts, a technique for removing “planty” off-flavors from plant-based protein is needed.

In plant cells, fat is stored in the form of oil bodies, also known as lipid droplets. These are small, spherical structures composed mainly of triglycerides and surrounded by a phospholipid monolayer with associated proteins. Oil bodies are found in various plant tissues, especially the seeds, where they serve as energy reserves for germination and growth. These seeds are the crops from which popular plant proteins are derived, including soybeans, oats, peas, chickpeas, faba beans, hempseed, sunflower seed, chickpeas, and many more.

During the extraction process, plant cells are homogenized and the cellular structures segregating proteins from bulk fat stores are broken, resulting in forced contact between fat molecules and protein s, including fat-degrading enzymes. As fat is broken down from triacylglyceride to fatty acid to lipid oxidation product, small molecule off-flavors are generated. As the extraction process is often carried out in an aqueous environment, these small, hydrophobic off-flavor molecules bind to the hydrophobic pockets on the surface of plant proteins and are co-purified with proteins themselves.

There are a number of techniques that currently exist for the removal of off-flavors from plant-based proteins, many of which rely on occurring during the extraction process to be effective. For example, rapid-hydration grinding processes, high pressure processing, pulsed electric field processing, ohmic heating, and cold plasma are known to inactivate enzymes that convert fat into off-flavor molecules(lipoxygenase, aldehyde, dehydrogenase). In addition, modification of traditional processing steps like steam distillation roasting, blanching, and soaking in alkaline solutions and/or solvents have been shown to inactivate enzymes such as trypsin inhibitors and lipoxygenases as well as remove fat. (Paul AA, Kumar S, Kumar V, Sharma R. Milk Analog: Plant based alternatives to conventional milk, production, potential and health concerns. Crit Rev Food Sci Nutr. 2020;60 (18):3005-3023, the entire content of which is incorporated herein by reference).

The removal of off-flavors from plant proteins post-purification is difficult as it relies on the use of food-safe methods that do not impact the protein's food functional properties (e.g. solubility, gelling, foaming). Ultrafiltration and tangential flow filtration using polyethersulfone (PES) membranes has been shown to remove methoxypyrizine, a common off-flavor in pea and soy proteins. Solvent extraction is a well-known technique for removing off-flavors from soybean and pea flours and protein isolates (U.S. Pat. No. 8,859,026 B2, the entire content of which is incorporated herein by reference), however this technique is expensive and limited due to the limited number of food-safe solvents. (See Yun Wang et al., “Impact of alcohol washing on the flavour profiles, functionality and protein quality of air classified pea protein enriched flour”, Food Research International, Volume 132, 2020, 109085, the entire content of which is incorporated herein by reference). The sequestration of off-floors via sorption has been explored in the literature, including the use of cyclodextrins to adsorb phospholipids and free fatty acids from soy protein (Damodaran S, Arora A. Off-flavor precursors in soy protein isolate and novel strategies for their removal. Annu Rev Food Sci Technol. 2013;4:327-46, the entire content of which is incorporated herein by reference), however this is not a commercially viable process.

In accordance with the present disclosure, a method for improving the taste of plant-based proteins is provided by extracting small hydrophobic molecules from a viscous protein solution using hydrophobic adsorbent resin with a large surface area in a batch-wise process. At the same time, the methods of the present disclosure are scalable and economical, allowing for ease of integration with current plant protein extraction processes or product development processes to improve the organoleptic properties of commercially available protein isolates, concentrates, and flours.

Polymeric adsorbents selectively remove hydrophobic small molecules from aqueous feed solutions. Adsorbent resins composed of hydrophobic co-polymers such as polydivinylbenzene or polystyrene cross-linked with divinylbenzene are used in a broad range of industrial, food, and pharmaceutical applications. These adsorbents bind exclusively to small, hydrophobic molecules, while hydrophilic small molecules and large polymers (e.g. proteins) freely flow through or around the resin. Hydrophobic adsorbent resins, composed of polymers like polydivinylbenzene or polystyrene cross-linked with divinyl benzene, can selectively remove these compounds. By treating this protein via contact with hydrophobic resin, high-concentration plant-based protein solutions can be treated, resulting in significantly improved taste and smell, regardless of the protein source.

Existing techniques for the purification of protein from plant material using polymeric adsorbents (such as the methods disclosed in US20220264907 A1) require that only dilute protein mixtures can be passed through a packed bed column for hydrophobic column adsorption. Consequently, a subsequent protein concentration step is often needed. The present invention circumvents these limitations by treating viscous feedstocks in a batch-wise manner that prevents system fouling. This improves economics as it requires less water and less energy input during subsequent drying steps. In addition, a method making use of ultrafiltration or other protein concentration steps may be disadvantageous with respect to microbiological controllability. The present invention allows the protein feedstock to be used directly in line with the production of foodstuffs, as a sufficiently concentrated protein solution is required for the protein to serve as a gelling agents, emulsifying agent, or perform other desired functions in food. The present invention also allows for the blending and deflavoring of various types of proteins simultaneously in the same step, allowing the user to capitalize on multiple desired functionalities that may come from different protein sources (emulsifying from one, gelling from another, etc).

The present disclosure provides for the use of hydrophobic adsorbent resin to capture and extract hydrophobic off-flavors from viscous plant-based protein solutions, dramatically improving their taste while allowing for the efficient use of water and energy during processing. This method has wide-ranging applications because the origin of off-flavors (lipid degradation) is conserved across multiple sources of plant-based proteins (legumes, oilseeds, cereals, tubers, etc.). In this method, a homogenized protein solution of high concentration contacts the adsorbent resin via dispersion and is co-agitated for a set period of time before removal, leaving behind a protein feedstock with dramatically improved taste and smell.

### Resin Adsorption Rationale

### Choosing Polymeric Adsorbents over Other Adsorbing Materials

Polymeric adsorbents are spherical synthetic polymers with well-defined pore structures and a high surface area, enabling effective and specific removal of organic molecules, primarily in aqueous environments.

Synthetic adsorbents consist of spherical polymer particles that are crosslinked and possess a porous structure with a large surface area. The adsorption of compounds onto these synthetic adsorbents is primarily driven by hydrophobic and pi-stacking interactions between the compounds and the adsorbents. Through advanced manufacturing techniques, synthetic adsorbents are designed with a highly porous structure, allowing them to adsorb a wide range of target compounds in significant quantities.

While synthetic adsorbents are often compared to activated carbons due to similarities in pore structure and adsorption mechanisms, there are notable distinctions between them. Synthetic adsorbents are created through polymerization, enabling precise control over pore sizes, which can range from tens to hundreds of angstroms. This characteristic empowers synthetic adsorbents to selectively adsorb specific compounds based on size exclusion. Additionally, synthetic adsorbents facilitate easier elution of adsorbed compounds compared to activated carbons. Furthermore, synthetic adsorbents are not only utilized for the removal of target compounds but are also widely employed in separation processes. Moreover, synthetic adsorbents generally have a longer lifespan compared to activated carbons. Further, activated carbons adsorb have the ability to adsorb not only hydrophobic small molecules but proteins as well. This feature of activated carbon prevents it from being used for the targeted removal of hydrophobic small molecules from concentrated protein solutions, as the carbon will become clogged with adsorbed protein.

Although synthetic adsorbents are often compared to alkyl-bonded silica gels, they exhibit exceptional resistance to acidic and caustic conditions. This unique attribute allows synthetic adsorbents to be employed under a variety of separation conditions, while experiencing minimal contamination from dissolved matter, unlike alkyl-bonded silica gels. Furthermore, synthetic adsorbents can endure caustic sanitization procedures that are unsuitable for alkyl-bonded silica gels. In some embodiments, synthetic adsorbents are made from poly(styrene-divinylbenzene) and polymethacrylate.

### The Choice of High Surface Area Aromatic Hydrophobic Adsorbent Resins Over Other Sorbants

The odor/flavor threshold for many off-flavor molecules is on the order of parts-per-billion (http://www.leffingwell.com/odorthre.htm); such that their partial removal may not result in an off-flavor free product, and that complete or nearly complete removal is necessary to make a sufficient impact on the taste profile of plant-based proteins.

There are many varieties of hydrophobic adsorptive resin. Unexpectedly, the present inventors have discovered that the sufficient removal of off flavors was not broadly facilitated by hydrophobic resins as a category, but that the selective off-flavor molecule removal from plant protein sources was dependent on both the chemistry and surface area of the resin considered.

Polystyrene resins are defined by their surface area and pore size. Ideally, the resin selected for the removal of off-flavors from protein molecules should possess a pore size small enough to prevent the entry of proteins (which would induce fouling) while possessing a large hydrophobic surface area. As the goal of contacting the sorbent with the protein is not to purify the protein from the solution but rather to out-compete the protein for its binding of hydrophobic small molecules by capturing them in the moment where they dissociate from the protein molecule. Thus, resins with large pore sizes are unsuitable for our purposes as their surfaces will quickly become blocked by proteins that migrate into the pores. This narrows the pool of commercially available resins and zeolites considerably.

The greater the surface area of the adsorbent, the greater the binding capacity, as more molecules can be adsorbed. One gram of resin has a high surface area, from 400 m²/gram to 1,200 m²/gram. Importantly, two resins with the same surface chemistry may possess different effective binding affinities toward a target compound due to the amplifying effect of surface area on hydrophobicity. The poly(styrene-divinylbenzene) resin HP20 (Itochu corporation) has a specific surface area of 590 m²/gram. Aromatic adsorbents such as poly(styrene-divinylbenzene) exhibit a strong affinity for hydrophobic molecules with a high electron density, such as unsaturated ring structures (e.g. benzene). The resin of these adsorbents attracts the aromatic groups of molecules, including tannins, and other similar compounds. Another category of hydrophobic adoptive resins include aliphatic (poly)methacrylate resins such as HP2 MG (Itochu Corporation) and PuroSorb PAD610 (Purolite) which are composed of ester copolymers.

In testing various resins for their ability to adsorb and reduce off-flavor molecules from viscous plant protein solutions, the authors screened multiple sorbets and sensorily evaluated the resulting deodorized protein solutions. Unexpectedly, the present inventors have found that neither aliphatic methacrylate resins nor low-surface area poly(styrene-divinylbenzene) resins (such as HP20) facilitate the efficient removal of lipid-derived off-flavors from viscous protein feedstocks. This finding is surprising due to the relatively low abundance of off-flavors present in plant protein solutions, which would require only a small percent of the available surface area of the resin for complete adsorption. The authors postulate that the reason for this high degree of hydrophobic surface area is the dynamic equilibrium that exists between protein, sorbent, and small molecule, which results in a competition between the protein and sorbent for binding to the small molecule. This finding led to the conclusion that only resins with sufficiently high hydrophobicity are suitable for off-flavor removal from plant protein feedstocks.

### The Advantages of Viscous Feedstocks

Aliphatic off-flavor molecules (L, ligand) associate with proteins (P, protein) via non-covalent interactions. The association and disassociation kinetics of a given off-flavor molecule and a given protein is governed by the law of mass action, which dictates that:

LP↔L+P

in which the ligand-protein complex LP breaks down into L subunits and P subunits. In this equilibrium equation, increasing the concentration of protein-ligand complexes drives the dissociation of that complex into individual subunits. In the present invention, the dissociated ligand (L) represents off-flavors that are subsequently removed from the system by adsorption to hydrophobic resin. This removal of free ligand (L) from the system further drives the dissociation of ligand-protein complexes.

Working with concentrated protein solutions presents a second advantage, as it enables the use of the off-flavor removal process described herein as an in-line unit operation in the creation of foodstuffs. Protein functionality in foodstuffs is concentration-dependent. This principle is most pertinent in the formation of self-supporting textures via protein gelation or extrusion. In gelation, a minimum concentration of protein is required for the formation of a three-dimensional protein network with the viscoelastic properties of a gel. For example, the minimum gelling concentration of legume protein isolates typically falls between 10-25% w/v. With the exception of fully hydrolyzed protein sources, the viscosity of such high-concentration protein solution is too high to pump through a packed bed column configuration.

### Impurities of Interest

A non-limiting list of chemicals that contribute to off-flavors in plant-based protein products is listed in Table 1. Off flavors that are removed by this process include but are not limited to lipid oxidation products, fatty acids, saponins, isoflavones, Maillard reaction products, cysteine-derived metabolites, tryptophan/phenylalanine metabolites, and polyphenols.

TABLE 1

| Chemical Class | Molecules Responsible for Plant Protein Off Flavors |
|---|---|
| Aldehydes | Hexanal, Pentanal, Butanal, Octanal, Nonanal, 2-Octenal, 3-Methyl-butanal, |
| | Benzaldehyde, 3-cis-hexenal, n-Hept-trans-2-enal, n-Heptanal |
| Alcohols | 1-Hexanol, 1-Octen-3-ol, 1-Pentene-3-ol, 3-Methyl-1-Butanol |
| Furans | 2-Pentyl-Furan |
| Ketones | 2-Butanone, 1-Octen-3-one, 3-Octen-2-one, 3,5-Octadien-2-on, ethyl vinyl |
| | ketone |
| Pyrazines | (Di)methylpyrazines, Methoxypyrazines |
| Phenols and Polyphenols | Phenolic acid, Gallic acid, Tannic Acid, Hexahydroxy diphenic acid, Ellagi- |
| | tannins, Proanthocyanidins, Flavan-3-ols |
| Aglycones/Isoflavones | Formononetin, biochanin A |
| Glycoalkaloids | Saponins 2,3-Dihydro-2,5-dihydroxy-6-methyl-4H-pyran-4-one (DDMP) |
| | saponin, Soyasaponin B, α-Solanine and α-Chaconine, Solanidine |
| Carotenoids | Lutein, Zeaxanthin |
| Fatty Acids | propionic acid (3:0), butyric acid (4:0), caproic acid (6:0), octanoic/caprylic acid |
| | (8:0), capric acid (10:0), lauric acid (12:0), and myristic acid (14:0), |
| | Pentanoic/Valeric acid (5:0), Hexanoic acid (6:0), heptanoic acid (7:1), |
| | octenoic acid (8:1), nonenoic acid (9:1), nonanoic acid (9:0), decadienoic acid |
| | (10:2), decenoic acid (10:1), decanoic acid (10:0), 9-undecenoic acid, 9- |
| | undecenoi acid, 9,11-dodecadienoic acid, oleic acids, linoleic acids, linolenic |
| | acids |
| Glycerol esters of fatty | Glycerol esters of fatty acids listed above |
| acids | |

### Positive Example 1: Viscous Potato Protein Defalvored in Batch-Mode

1. One liter of 17.5% w/w Solanic 200 (Royal Avebe) potato protein solution was prepared and adjusted to pH 8 with 1M NaOH (Sigma). The protein was allowed to fully hydrate by stirring at low speed for 30 minutes.
2. The viscosity of the protein solution was recorded to be 800 mPa*s.
3. 50 g of wetted SP700 (Itochu Corporation) hydrophobic adsorption resin was added to the protein solution, which is a poly(styrene-divinylbenzene) with a specific surface area of 1200 m²/g, a pore radius of 90 Å, and a pore volume of 2.1 mL/g.
4. Using a low-shear impeller, the resin was incorporated into the protein solution and suspended with gentle agitation at 300 rpm.
5. The protein-resin solution was incubated with agitation for 3 hours at 4° C.
6. The resin was separated from the viscous protein solution by passing the protein solution twice through a 100-micrometer sieve.
7. A control solution was prepared following the above steps while omitting the resin.
8. The resultant de-flavored and control protein solutions were directly incorporated into a plant-based fish prototype and cooked in an oven for 20 minutes at 350° F.
9. A sensory panel (n=7) tasted the plant-based fish prototypes. Results of the sensory are in Table 2.

TABLE 2

| | Tasting Notes on | |
|---|---|---|
| Panelist | Prototype with SP700-Treated Protein | Control Prototype with Untreated Protein |
| 1 | Flavor is subtle. Some umami. | Smells is very earthy/potato |
| 2 | No potato. Butter comes up and not much else. | n/a - gel didn't infuse properly |
| 3 | Some subtle earthy/potato notes were detected | Potato + rancidity flavor detected |
| 4 | Significantly bland. | n/a - not completely infused. |
| 5 | Not much of a potato taste | Earthy and slightly bitter. Strong potato taste. |
| 6 | No fishy flavor was detected, earthy flavor still there | Potato flavor was predominant |
| 7 | Doesn't taste like much to me. | Bitterness comes in strong |

### Negative Example 1: Use of Viscous Feedstock on Packed Bed Configuration

1. Three liters of 12.5% w/w Solanic 200 (Royal Avebe) potato protein solution was prepared and adjusted to pH 8 with 1 M NaOH (Sigma). The protein was allowed to fully hydrate by stirring at low speed for 30 minutes.
2. The viscosity of the protein solution was recorded to be 5 mPa*s.
3. The protein solution was applied to a large diameter chromatography column (Ace Glass) filled with SP700 hydrophobic adsorbent resin (Itochu Corporation) in a packed bed configuration with a bed depth of 60 cm.
4. Upon contact, the packed bed system quickly became clogged with the proteinaceous feedstock. A cake of precipitated protein was observed to have formed on the surface of the packed resin material, inhibiting flow through the packed bed.

### Negative Example 2: Use of Expanded Bed Chromatography Resins

Expanded Bed Adsorption (EBA) Chromatography is an industrially leveraged chromatographic separation technique for processing viscous feedstocks. Using hydrophobic-interaction-chromatography (HIC) resins with diethylaminoethyl (DEAE) and benzylamine chemistries, we attempted to treat our feedstock and found that they did not materially impact the flavor of the resultant protein solution.
1. Made 16.67% solids protein solution (500 g in 3 L) using Solanic 200 (Royal Avebe). Stirred for 30 minutes to fully hydrate.
2. Gently added resin:
   a. EBA Resin 1: Fastline Benzylamine (Upfront Chromatography)
      i. Used 100 mL rinsed resin per 1 L protein solution.
   b. EBA Resin 2: Fastline L DEAE (Upfront Chromatography)
      i. Used 100 mL rinsed resin per 1 L protein solution.
   c. SP700 (Itochu Corporation)
      i. 50 mL rinsed resin per 1 L protein solution.
   d. Control-no resin added
3. Samples were continuously agitated at 4*C for 12 hours.
4. Resin was removed via filtration.
5. Potato protein solutions were gelled at 80*C for 30 minutes and allowed to cool.
6. A sensory panel (n=4) tasted the resultant protein gels.

| Resin | Panelist 1 | Panelist 2 | Panelist 3 | Panelist 4 |
|---|---|---|---|---|
| SP700 | Muted potato | Least potato | Slightly less potato | Very neutral, sl metallic, I |
| | notes. Smells like | flavor. Still | than A but still have | starchy. Not bitter at all. |
| | potato chips. | astringent, a bit | potato in there. Slight | Kokumi. Very clean |
| | Astringent notes. | eggy/sulfur. | bitterness. The least | tasting. |
| | Dusty. Best | | off flavors. | |
| | sample. | | | |
| EBA Resin 1 | Potato notes. | Potato notes | Potato flavor upfront, | Potato chips. Not bitter. |
| | Some | | earthy. What I | Yesterday I remember |
| | acrid/poison | | remember the samples | tasting a baked potato |
| | notes. | | tasting like that we | taste remaining. |
| | | | don't deflavor or have | Earthiness and bitterness |
| | | | any maskers. | are reduced. |
| EBA Resin 2 | Back end | Potato, drying, | Highest potato flavor | Slightly umami. Kokumi. |
| | acrid/noxious | astringent | among all samples. I | Less astringent. No |
| | taste with potato | | felt like this was the | potato notes. Not bitter. |
| | notes. | | control. | There's something |
| | | | | volatile happening on the |
| | | | | back of my palette that's |
| | | | | hard to describe. |
| Control - No | Drying/Very | Highest potato | Most potato notes. | Smell is potato-y Taste is |
| Resin | astringent. Muted | flavor. Musty. | | stale and musty. Like a |
| | potato notes. | | | basement, licking dust. |
| | Starchy. | | | Astringent. |

1. A method for removal of lipid-derived off-flavor molecules from a raw protein solution, the method comprising contacting the protein solution with a high surface area hydrophobic adsorption resin and/or zeolite surface, and collecting an eluate from said hydrophobic adsorption resin and/or zeolite surface, the eluate having reduced lipid-derived off-flavor molecule content compared to the raw protein solution.

2. The method of claim 1, wherein the hydrophobic adsorption resin and/or zeolite surface is an aromatic hydrophobic adsorption resin surface.

3. The method of claim 1, wherein the hydrophobic adsorption resin and/or zeolite surface comprises a hydrophobic adsorption resin and/or zeolite bead.

4. The method of claims 1, wherein the hydrophobic adsorption resin and/or zeolite surface has a surface area of at least 600 m²/g.

5. The method of claim 4, wherein the hydrophobic adsorption resin and/or zeolite surface has a surface area of at least 700 m²/g.

6. The method of claim 5, wherein the hydrophobic adsorption resin and/or zeolite surface has a surface area of at least 800 m^{2 /g.}

7. The method of claim 6, wherein the hydrophobic adsorption resin and/or zeolite surface has a surface area of at least 900 m²/g.

8. The method of claim 7, wherein the hydrophobic adsorption resin and/or zeolite surface has a surface area of at least 1000 m²/g.

9. The method of claim 1, wherein the raw protein solution comprises an aqueous solution.

10. The method of claim 1, wherein the raw protein solution comprises 0.5%- 50% solids.

11. The method of claim 1, comprising batch-wise removal of the lipid-derived off-flavor molecules from the raw protein solution.

12. The method of claim 11, wherein the raw protein solution is a viscous protein solution.

13. The method of claim 12, wherein the raw protein solution comprises 5% or more solids.

14. The method of claim 11, comprising dispersing the hydrophobic adsorption resin and/or zeolite surface in the raw protein solution to form a mixture, agitating the mixture, and separating the eluate from the mixture.

15. The method of claim 14, comprising continuously agitating the mixture for at least 30 minutes.

16. The method of claim 1, for selective removal of lipid-derived off-flavor molecules.

17. The method of claim 1, wherein the raw protein solution comprises protein from pea, soy, chickpea, faba, mung bean, rice, oat, or potato isolates or concentrates, or combinations thereof.

18. The method of claim 1, wherein the hydrophobic adsorption resin and/or zeolite surface is made from poly(styrene-divinylbenzene) and/or polymethacrylate.

19. The method of claim 1, further comprising concentrating the eluate via filtration after removal of the lipid-derived off-flavor molecules.

20. The method of claim 1, further comprising spray drying the protein from the eluate after removal of the lipid-derived off-flavor molecules.
